(19) United States
(12) Patent Application Publication
(10) Pub. No.: US 2025/0209103 A1
(43) Pub. Date: Jun. 26, 2025

(54) MISSING CONTROL IDENTIFICATION

(71) Applicant: PAYPAL, INC., San Jose, CA (US)

(72) Inventors: Zuheb Zafar, Woodridge, IL (US); Li Cao, San Jose, CA (US); Sunitha Mangisetty, Santa Clara, CA (US)

(21) Appl. No.: 18/390,346

(22) Filed: Dec. 20, 2023

(51) Int. Cl. G06F 16/338; G06F 16/35; G06F 16/383

(52) U.S. Cl. CPC G06F 16/338; G06F 16/35; G06F 16/383

(57) ABSTRACT

Systems and methods for determining control objective for electronic documents using models may include obtaining electronic documents and a control objectives library, determining a first set of summaries based on the electronic documents, extracting a set of embeddings from the control objectives library, and determining a set of control objectives based on the summaries and the embeddings. The method may also include determining control objective candidates based on the summaries and embeddings, ranking the control objective candidates based on a confidence score, filtering the control objective candidates based on the ranking, categorizing the control objectives candidates into a second and third set of control objectives, updating the control objectives library to include one or more control objectives from the third set of control objectives, and validating control objectives in the third set of control objectives based on a test plan and updating the control objectives library that pass validation.

### FIELD

The present disclosure relates to the field of data processing. More particularly, to using neural network models for identification and association of missing control objectives to data.

### BACKGROUND

A business or organization is commonly exposed to a variety of risks as part of their normal operations. For example, financial entities operate in a highly regulated industry and are faced with many risks associated with conducting financial transactions. Organizations commonly implement policies and procedures that outline the strategy for managing risks associated with the organization's operations. To ensure the organization adheres to their policies and procedures, controls are established addressing the potential risk based on the relevant regulatory requirements, policies, procedures, and other similar factors.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram illustrating a system for identifying control objectives from electronic documents, according to some embodiments.

FIG. 2 is a flow diagram of a method, according to some embodiments.

FIG. 3 is a diagrammatic view of a system performing the method in FIG. 2, according to some embodiments.

FIG. 4 illustrates a flow diagram of a method, according to some embodiments.

FIG. 5 illustrates a diagrammatic view of a system performing the method in FIG. 4, according to some embodiments.

FIG. 6 illustrates a diagrammatic view of a system performing the method in FIG. 4, according to some embodiments.

FIG. 7 illustrates a flow diagram of a method, according to some embodiments.

FIG. 8 illustrates a flow diagram of a method, according to some embodiments.

FIG. 9 is a diagrammatic view of a system performing the method in FIG. 8, according to some embodiments.

FIG. 10 is a block diagram illustrating a network-based system, according to some embodiments.

### DETAILED DESCRIPTION

Entities and organizations typically operate in furtherance of their business objectives based on guidelines established based on various laws, regulations, and internal policies and procedures. These different guidelines can be captured as electronic documents, which can be stored in a database of the entity. Based on these guidelines, the entity can evaluate for risks associated with the guidelines and can implement various controls and control objectives to enable the entity to operate according to the established guidelines. For example, the entity can provide an online network for users (e.g., online merchants) to sell their goods and services to other users (e.g., customers) using the online network and the entity can process the electronic documents to identify and implement control objectives at one or more computing devices in the online network to reduce risks to the entity and to comply with the guidelines established according to the electronic documents. In another example, the entity can be a financial organization that provides the online network to users for performing online financial transactions with the entity and other users, and the entity can identify and implement controls in the online network based on the control objectives to mitigate risks associated with users disguising illegally obtained funds as legitimate income to ensure the entity maintains compliance with certain regulatory requirements.

Conventional approaches to monitoring electronic documents to identify and implement appropriate control objectives to maintain compliance with guidelines provided in electronic documents typically includes personnel associated with the entity manually identifying changes to the guidelines based on the document's content, determining the changes are related to the entity's operations, inferencing risks being addressed by the guidelines, and identifying and/or implementing control objectives and controls based on the guidelines.

An entity's operations can be based on a plurality of guidelines, which can be captured across a large number of different electronic documents that can total in the thousands of pages of text, hundreds of thousands of pages of text, or more. In addition, the different electronic documents, control objectives, citations, risks, controls, etc. can result in very large datasets that may be difficult for the entity's personnel to actively monitor. For example, a dataset can include 1000+ regulatory documents, 10,000+ citations, 3000+ control objectives, and associated risks and controls. Manual monitoring for changes to the guidelines, evaluating the text to inference whether an entity is affected by the guidelines, and implementing controls based on control objectives associated with the guidelines can be challenging. In particular, even with dedicated personnel to perform these processes, these processes can be labor intensive and time consuming due to the amount of data being processed. As such, it can be a challenge to actively monitor for changes to guidelines and to then ensure that appropriate control objectives are established to address the risks associated with the guidelines. Consequently, effective identification and implementation of control objectives in a timely manner may be delayed due to the challenges associated with manual implementation. Even using computing devices to collect, store, and process the data using known conventional techniques and methods, effective implementation may be challenging due to the size of the datasets and due to the amount of manual user input that may be required to process the pipelines. For example, identification and implementation of one or more control objectives based on guidelines providing for authentication requirements for external users associated with the entity, e.g., contractors employed by the entity, to be able to access and use one or more computing devices in an online network of the entity may be delayed due to delays stemming from the challenges associated with processing the guidelines, thereby subjecting the entity to increased risks due to missing or delayed identification and implementation of the control objectives in the online network.

Even with dedicated resources for processing the guidelines, the identification and implementation of control objectives based on the guidelines can be prone to errors due to the number of guidelines being processed and due to the large number of data points that may need to be evaluated during the processing. Accordingly, the challenges associated with manual implementation and management of control objectives for the guidelines, even when using a computing device or tool to perform the processing operations, can lead to poor performance, poor risk management practices, and can expose the organization to reputational damage or other negative consequences.

Various embodiments of the present disclosure relate to network-based systems, computing devices, and computer-implemented methods for automating processing of data corresponding to electronic documents to identify gaps in the control objectives in the network based on the electronic document's context, the gaps corresponding to missing control objectives. The control objectives may also be determined based on the risks and controls associated with the electronic documents, control objectives, or both. The one or more embodiments described herein may accomplish this by leveraging one or more neural network models applying one or more techniques and/or algorithms to the data corresponding to the electronic documents and control objectives library to determine one or more control objectives that may be associated with the electronic documents based on the context.

In various embodiments, the processing tasks may be performed by a computing device. The computing device may be a network-based computing device in a network associated with an entity. The network may include one or more computing devices for performing the processing tasks. The computing device may perform data processing pipelines on electronic documents, that is, the identification of missing control objectives by the computing device may be performed in response to changes to electronic documents (e.g., new or revised electronic documents) determined based on the text data therein. The neural network models of the computing device may apply the one or more techniques and/or algorithms to data including text data in electronic documents, citations, control objectives, risks, controls, etc., to associate control objectives from the control objectives library with the electronic documents, citations, or both, and, in some embodiments, to determine new control objectives that may be missing from the control objectives library. The control objectives may also be determined based on the risks and controls associated with the electronic documents, citations, control objectives in the control objectives library, or any combinations thereof.

The computing device may obtain the electronic documents and leverage the one or more models, techniques, and/or algorithms to analyze the text data in the electronic documents to learn the electronic document's context. The computing device may apply the models to the text data in the electronic documents and generate summaries of the electronic documents to enable determining control objectives based on the context. In addition, one or more of the electronic documents may include citations. The computing device may also apply the models to the citations, and the text thereof, and extract embeddings from the citation text to further enable determining control objectives to associate with the electronic documents. In this regard, the term “citation” refers to a portion or portions of electronic documents (e.g., text data in electronic regulatory documents) that refers to specific standards/guidance that organizations are expected to follow. Based on the citation text (i.e., key terms and phrases), and its area of law, the model identifies the relevant control objectives.

The computing device may also determine associated risks and controls based on the electronic documents, citations, control objectives, or any combinations thereof. In some embodiments, the risks and controls may be determined based on the context of the electronic documents, the citations, the control objectives in the control objectives library, or any combinations thereof. In other embodiments, the risks and controls may be in corresponding datasets or libraries and stored in a datastore such as, for example, the memory of the computing device. The risks and controls may be associated with the electronic documents, control objectives, or both, based on the processing tasks performed by the computing device using the neural network models.

The computing device may also utilize the models to generate summaries of the electronic documents, citations, control objectives, or any combinations thereof. The computing device may also, based on the control objectives summaries, extract embeddings. Based on the one or more summaries and based on the embeddings the computing device may be configured to determine control objective candidates based on the electronic document summaries and control objectives embeddings provided as output. In addition, in some embodiments, the control objective candidates may be further determined based on an input prompt provided to the model along with the summaries and embeddings. That is, prompt engineering may be utilized to create/design inputs to the models that enable the computing device to then identify one or more control objective candidates to associate with the electronic documents. In this regard, prompt engineering may be leveraged to refine a number of control objective candidates determined by the models based on the summaries and embeddings also provided to the model as input.

The identified control objective candidates may include mapped and missing control objectives. The mapped control objectives may correspond to control objectives in the control objectives library that may already be associated with the electronic document(s). The unmapped control objectives may correspond to control objectives that may not be associated with the electronic document(s). For example, an electronic document establishing guidelines for certain users (e.g., contingent workers) to access computing devices in a network associated with the entity may be revised to provide that the users cannot gain access to the network until certain security authentications have been completed, and the computing device may thereby determine control objectives providing that the user profiles associated with the certain users in the network cannot be activated before a point in time when the security authorizations have been completed such as, for example, based on timestamp data associated with the completion of the security authentications. In some embodiments, the unmapped control objectives may include control objectives in the control objectives library. In other embodiments, the unmapped control objectives may include control objectives not in the control objectives library; that is, the computing device may generate new control objective candidates that may be predicted using the neural network models based on the electronic documents and the associated risks and controls.

In various embodiments, the computing device may be in electronic communication with one or more other computing device in the network, and the computing device performing the processing tasks may send the output dataset to one or more of the other computing devices. In some embodiments, the other computing devices may be for users associated with the entity responsible for implementing the control objectives in the network based on the guidelines embodied in the electronic documents. In addition, the other computing devices may include therein one or more applications for performing operations including placing the user's computing device in electronic communication with the computing device performing the processing pipeline jobs, requesting data processing pipelines, sending and receiving data associated with the processing tasks including output datasets, displaying information on a user interface/graphical user interface, receiving one or more user inputs, other like features, or any combinations thereof.

The one or more applications may include a user interface/graphical user interface to enable viewing the data associated with the control identification processing on a display of the user's computing device and to provide one or more inputs such as, for example, corresponding to the user's selection of one or more of the control objective candidates for implementation into the network. The user interface/graphical user interface may also receive the one or more inputs from the user, including the user's selection of control objectives for implementation into the network, and send the data corresponding to the user's selection to one or more other computing devices, including the computing device performing the data processing pipelines. For example, the computing device that performed the processing tasks for predicting the candidate control objectives may obtain the user's selections as input and the computing device may train the neural network models based on the user's selections to improve future processing tasks by the computing device using the neural network models.

In various embodiments, the identified control objective candidates may be validated. In some embodiments, the control objective candidates may be validated prior to implementation in the network. For example, the computing device may validate the control objectives obtained from the user's computing device and selected by the user prior to implementation into the network. In other embodiments, the control objective candidates may be validated prior to including the control objective candidates in the output dataset that is sent to the user's computing device for selection for implementation in the network by the user. The validation may include executing a test plan on the control objectives in the network, or in a test network environment, to enable determining whether the control objectives address the electronic documents and the associated risks identified in the electronic documents. If the control objective passes validation, the computing device may update the control objectives library. If the control objective fails validation, the control objective may not be included in the mapped control objectives. In addition, the neural network models may be trained using a reference dataset. The reference dataset may include the electronic documents, associated mapped control objectives, risks, controls, and the like, that may be utilized by the neural network models to perform the techniques and/or algorithms described herein. The reference dataset may be updated with the data based on the user's selection of the control objectives for association with the electronic documents and based on passing the validation, to enable the models to use the trained reference data to improve the control objective determination during subsequent processing pipeline requests; that is, the computing device may iteratively train the models with validated data to enable improved identification of control objectives in future processing pipelines, and to enable improved prediction of control objectives not included in the control objectives library. In this regard, the one or more embodiments described herein relate to improvements for processing large scale datasets including a large number of data points to determine control objective candidates to associate with electronic documents based on the context of the corresponding text data, and to determine control objective candidates to associate with the electronic documents using the one or more models, techniques, and/or algorithms described herein.

It is to be appreciated by those having ordinary skill in the art that the one or more embodiments of the present disclosure are directed to improvements to conventional techniques and methodologies for associating control objectives in a control objectives library with electronic documents. The improvements include the computing device leveraging one or more neural network models such as, for example, natural language processing (“NLP”) models, large language models (“LLMs”), artificial intelligence models (“AI”), and other like models, to perform one or more processing tasks of a processing pipeline on text data of electronic documents, control objectives, citations, risks, and controls. The processing tasks may include determining the context of the text data using the one or more models, generating text data corresponding to summaries based on the electronic documents and control objectives, extracting embeddings, and determining control objective candidates that may be associated with the electronic documents. It is also to be appreciated by those having ordinary skill in the art that the operations as described herein may not be limited to processing electronic documents as input for the purposes of determining missing control objectives but may also be applied to a plurality of different types of data using the one or more models. The data for processing by the computing device may include text data. In some embodiments, the data may include, but is not limited to, text data, image data, video data, graphical data, other like data, or any combinations thereof.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

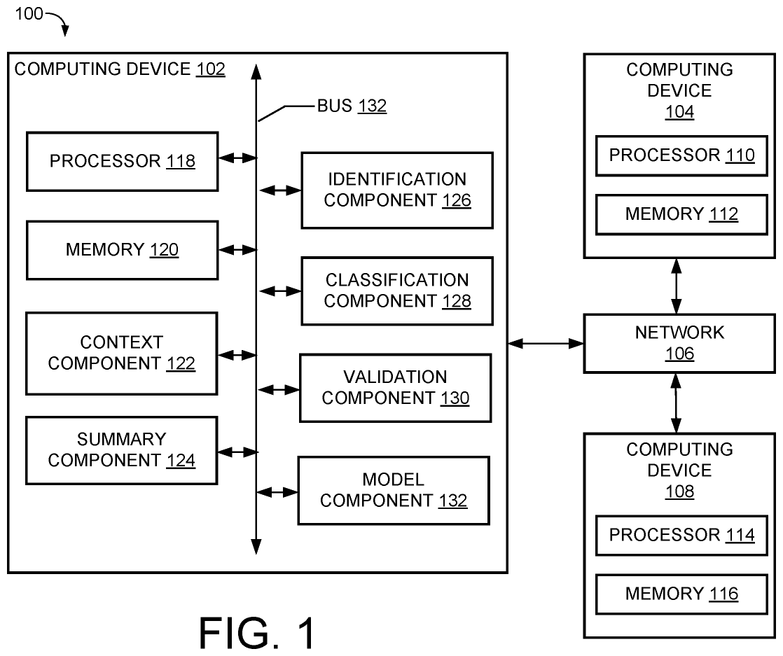

FIG. 1 is a block diagram illustrating a system 100 for identifying control objectives from electronic documents, according to some embodiments. The system 100 may include computing device 102, a computing device 104, a network 106, and computing device 108. The computing device 102 may be in electronic communication with the computing device 104. The computing device 104 may be configured to perform data processing pipelines to identify changes in electronic documents, citations, and associated risks and controls. The computing device 104 may include a processor 110 and a non-transitory computer readable memory 112 media having stored therein data corresponding to electronic documents, citations, control objectives, risks, controls, summaries, other data, or any combinations thereof. The data stored in memory 112 may be organized in one or more data stores or libraries, e.g., electronic document libraries, control objectives libraries, risk libraries, control libraries, etc. The computing device 104 may include one or more functional modules embodied in the memory 112 executable by processor 110 for performing operations similar to computing device 102, as will be further described herein. In this regard, the computing device 104 may act in cooperation with computing device 102 to perform operations in accordance with the present disclosure. In some embodiments, the computing device 104 may be in electronic communication with the computing device 102 via network 106.

The system 100 may include computing device 108. The computing device 108 may be in electronic communication with computing device 104 and/or computing device 102. The computing device 108 may include a processor 114 and a non-transitory, computer readable memory 116 media. The computing device 108 may be a computing device of a user and may have stored therein one or more applications capable of displaying a user interface or graphical user interface on a display of the computing device 108 to display data produced by computing device 102 based on applying the one or more techniques as will be further described herein. In some embodiments, the computing device 108 may be in electronic communication with computing device 104 and computing device 102 via network 106.

The computing device 102 may include a processor 118 and a non-transitory, computer-readable memory 120 that contains instructions that, when executed by the processor 118, cause the computing device 102 to perform operations, processes, methods, etc. described herein with respect to computing device 102. The computer-readable memory 120 may contain data including, but not limited to, electronic documents, citations, controls, risks, control objectives, other data, or any combinations thereof. The computing device 102 may include one or more functional modules embodied in computer-readable memory 120. The functional modules may include a context component 122, a summary component 124, an identification component 126, a classification component 128, a validation component 130, a model component 132, and a bus 136.

The instant disclosure refers to data corresponding to electronic documents, control objectives, summaries, embeddings, risks, controls, associations therebetween, other data objects, and their attributes. Such data may be common to a network, a particular network of the organization, a particular processing request, etc. For example, the data may be common to network 106 of system 100. In another example, the data may be analyzed using the one or more functional modules of computing device 102 for determining control objectives for implementation in system 100 of an entity. For example, the electronic documents may provide for regulatory requirements and risk mitigation practices by an entity in association with money laundering and terrorist financing activities by third parties and the control objectives may be configured to ensure compliance by one or more external computing devices associated with the third parties performing online transactions in system 100 of the entity.

The context component 122 may obtain data as input corresponding to electronic documents such as, for example, new electronic documents or revisions to electronic documents. In some embodiments, the data obtained as input by context component 122 may be from data processing pipelines performed by one or more computing devices, hereinafter referred to as computing device 104, which identifies and alerts for such changes to electronic documents of the entity associated with system 100. For example, the input data may correspond to electronic documents providing for changes to anti-money laundering obligations by the entity associated with system 100 for new products/services before the entity can perform online transactions (e.g., buy, sell, trade, etc.) the products/services in the system 100.

The data obtained by context component 122 as electronic documents may include therein citations. For example, the citations may be a portion or portions of the electronic document (as text data) that refers to the specific standards, guidance, and/or law that organizations are expected to follow. That is, the citations may provide additional context to the electronic documents. In some embodiments, the data may also include controls and risks associated with the document. The context component 122 may also obtain the electronic document(s) and analyze the electronic document using the neural network models of the computing device 102 to identify controls and risks associated with the electronic documents based on the text data. In some embodiments, the data may be associated with an alert indicating a change to an electronic document (e.g., revision to an existing document, new document, etc.) requiring a determination of whether any control objectives such as, for example, from the control objectives library may need to be associated with the electronic document.

The context component 122 may also send the obtained data to summary component 124 to enable generating summaries of the data, as will be further described herein. The data obtained by context component 122 may correspond to electronic documents, citations, controls, risks, and other like data.

The data may be sent to computing device 102 and context component 122 as an alert based on execution of the pipeline by the computing device 104. For example, the alert may be generated based on the pipeline identifying changes to text data in electronic documents in the system 100. In some embodiments, the data obtained by context component 122 may include new electronic documents, new citations, controls, risks, other similar data, or any combinations thereof. The context component 122 may periodically query and obtain the data packets as alerts from the computing device 104, according to some embodiments. In addition, the context component 122 may send and receive data to computing device 104 including summaries, embeddings, citations, new mappings of control objections, etc. based on the application of the one or more techniques in accordance with the present disclosure.

The summary component 124 may obtain data from context component 122 and analyze the data using one or more neural network models to generate summaries of the data. For example, the data from context component 122 may include one or more electronic documents, citations, a library of control objectives and associated controls and risks. The neural network model may analyze the obtained data and generate as output summaries of the electronic documents and summaries of associated control objectives based on context in the data. In this regard, the neural network model analyzes the text data in the electronic documents and control objectives in the control objectives library and generates a summary for each of the electronic documents and the control objectives. The neural network model may also extract embeddings from the control objectives summaries. In this regard, the neural network model applies computer-based mathematical algorithms to the input data to determine the semantic and syntactic meaning of the input data, to determine the context, and to enable generating the summaries and extracting the embeddings for identifying one or more control objectives in the control objectives library that may be associated with each electronic document based on the controls and risks associated therewith. In addition, in some embodiments, the summaries and embeddings may also be used to identify new control objectives that may not be in the control objectives library.

The identification component 126 may obtain data including the document summaries and the control objective embeddings from the summary component 124. In some embodiments, the data from the summary component 124 may further include the control objectives library. In other embodiments, the data from the summary component 124 may further include the risks and controls. The identification component 126 may analyze the document summaries and control objective embeddings and may identify one or more control objective to associate with the electronic documents as candidates based on the input.

The one or more control objective candidates may include mapped control objectives that were previously already associated with the corresponding electronic documents. The one or more control objective candidates may also include missing control objectives that were not previously identified by the neural network model as being associated with the corresponding electronic documents. In some embodiments, the missing control objectives may include new control objectives that are predicted by the neural network model as being candidates that may be associated with the electronic documents based on the processing of the electronic documents, citations, control objectives library, risks, controls, other like data, or any combinations thereof.

The identification component 126 may also filter the control objective candidates. In some embodiments, identification component 126 may filter for the top n-number control objectives based on one or more factors. For example, the identification component 126 may select the top 15 control objectives based on the similarity between the electronic document summary and the embeddings.

The identification component 126 may identify control objective candidates based on a prompt further provided as input to the neural network model. The prompt may be engineered such as, for example, by a user as input to provide the neural network model additional criteria for identifying one or more additional control objectives based on the document summaries and associated control objective embeddings that were not previously identified by the neural network model at summary component 124, that is, the prompt may be engineered to provide additional context to the neural network model to enable identifying control objectives from the control objectives library based on one or more parameters not available to the neural network model at summary component 124. In this regard, the prompts may include text data that is created/designed and provided as input to the models to enable the model to identify control objects.

The classification component 128 may obtain the control objective candidates from identification component 126 and may categorize the control objectives as mapped and unmapped control objectives. The mapped control objectives corresponding to control objectives in the control objectives library identified by the neural network model as being associated with the electronic documents, and the unmapped control objectives corresponding to control objectives identified by the neural network model as not previously being associated with the electronic documents in prior iterations of processing the data corresponding to the electronic documents, citations, risks, controls, and the like. In this regard, the computing device 102 is capable of identifying the top-n number of related control objectives to the electronic documents, citations, or both. In some embodiments, the computing device 102 may then further classify these identified control objectives based on their prior mapping to the electronic documents, citations, or both.

The classification component 128 may thereby generate a dataset as output corresponding to the mapped and unmapped control objectives. The computing device 102 may send the dataset to computing device 104 to associate the control objectives in the output dataset and also in the control objectives library with the electronic documents. In some embodiments, the computing device 102 may send the dataset to computing device 104 to iteratively update the control objectives library with new control objective candidates and to associate the new control objectives with the electronic documents and/or citations.

The computing device 102 may, according to some embodiments, send the dataset output by the classification component 128 to computing device 108. The computing device 108 may display the data in the user interface or graphics user interface such as, for example, on a display associated with the computing device 108. For example, the computing device 108 may obtain the dataset from computing device 102 and may display the mapped and unmapped control objectives determined based on the summaries and embeddings and associated with the corresponding electronic documents and/or citations. In some embodiments, the computing device 108 may, as a result of receiving the dataset output by computing device 102 and displayed on the user interface, obtain one or more inputs at the user interface, the one or more inputs corresponding to a selection of one or more of the control objective candidates from the output dataset to add to the control objectives library, the control objectives being associated with corresponding electronic documents and/or citations. For example, a user associated with computing device 108 may select one or more of the control objective candidates in the output dataset obtained from computing device 102 to add to the control objectives library.

The computing device 102 may thereby be capable of automatically identifying the top-n control objectives for an electronic document or electronic documents without necessitating manually associating the electronic document with thousands or tens of thousands of data points populating the control objectives library and based on controls and risks associated with each control objective and without necessitating manually determining associations therebetween based on the appropriate risks and controls.

One or more datasets generated by the neural network models during the processing, e.g., summaries, embeddings, control objectives, etc., may be used to train the neural network model to enable improved identification and recommendation of control objective candidates. In some embodiments, the neural network model may be trained using data corresponding to control objectives selected for integration into the system 100 and/or computing device 104 rather than each of the top-n control objectives provided as output by the identification component 126 and classification component 128.

The validation component 130 may validate the control objectives prior to training the neural network model. The validation component 130 may determine the efficacy of the control objective before training the model with the data corresponding to the control objective. For example, for the control objective establishing that security authentication for contingent workers be complete at a point in time prior to, t-n, contingent workers being given access to network 106 at time, t, the validation component 130 may collect and measure data generated on the system 100 to determine whether the control objective implemented in system 100 is effective prior to training the model with the control objective.

The model component 132 may include the neural network model. One or more of the components of computing device 102 may apply the one or more techniques and/or algorithms of the neural network model to data to perform operations including predicting control objectives for electronic documents. The model component 132 may include a first neural network model and a second neural network model. For example, in some embodiments, the summary component 124 may apply the first neural network model to the electronic documents and the control objectives in the control objectives library to generate the summaries and embeddings therefrom, and the identification component 126 may apply the second neural network model to the summaries and embeddings to determine control objective candidates that may be associated with the electronic documents based on the summaries and the embeddings. The control objective candidates determined by the second neural network model may include mapped control objectives from the control objectives library and unmapped control objectives from the control objectives library. In some embodiments, the unmapped control objectives determined by the neural network model may further include new control objectives that may not be included in the control objectives library, that is, the neural network model may, based on the context of the input(s), may predict new control objectives in the unmapped control objectives that were not previously included or defined in the control objectives library. In some embodiments, the model component 132 may include two or more neural network models. For example, the model component 132 may include prior iteration models and current iteration models trained using data generated as a result of the previous iteration neural network model processing data for the pipeline job in the computing device 102.

The neural network models may leverage one or more algorithms and techniques trained using datasets containing a large number of data points (e.g., millions of data points) to perform various processing tasks. For example, the models may include deep learning algorithms to perform natural language processing (“NLP”) tasks using transformer models. The neural network models may thereby be trained to perform a plurality of different processing tasks including, but not limited to, recognition, translation, encoding, prediction, generation, other processing tasks, or any combinations thereof.

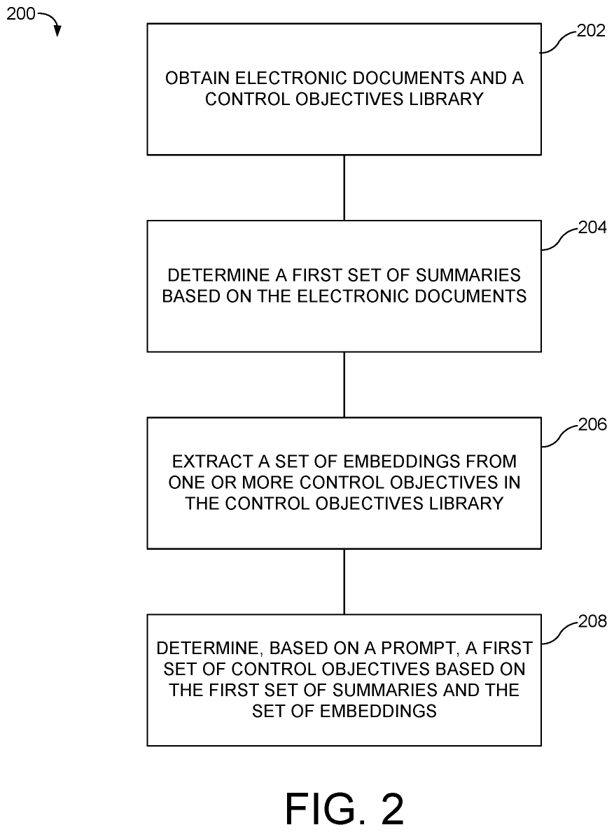

FIG. 2 is a flow diagram of a method 200, according to some embodiments. The method 200, or one or more portions thereof, may be performed, for example, by the computing device 102 of FIG. 1, and thus may be computer-implemented.

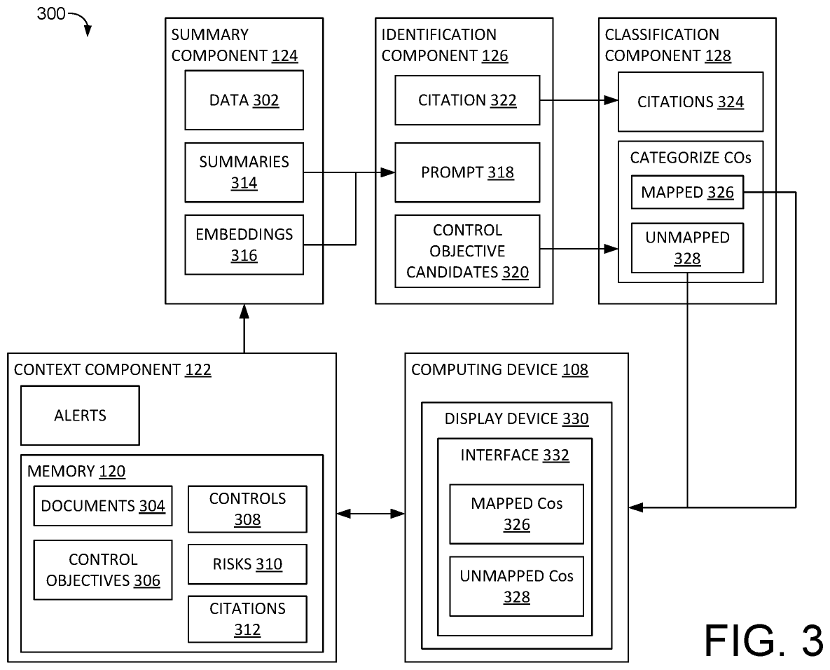

FIG. 3 is a diagrammatic view of a system 300 performing the method 200, according to some embodiments. The method 200 will be described in conjunction with the system 300.

At 202, the method 200 includes obtaining a dataset corresponding to electronic documents and a control objectives library. The electronic documents may be obtained by a computing device as an alert, the alert including data corresponding to the electronic documents. The electronic documents may include new electronic documents, revised electronic documents, or a combination thereof. Each electronic document includes therein text data that may be analyzed by a computer-based model of the computing device such as, for example, a neural network model, to determine the context of the text data to enable the computing device to determine control objective candidates associated with the electronic documents in accordance with the present disclosure.

The electronic documents may include one or more electronic documents, according to some embodiments. In some embodiments, the electronic documents may include a plurality of electronic documents. The electronic documents may be obtained by a computing device in a network, the computing device may be configured to perform data processing operations including determining control objective candidates based on the electronic documents and based on the control objectives in the control objectives library. The control objectives library includes a plurality of control objectives therein. In FIG. 3, the dataset may correspond to dataset 302, the one or more electronic documents may correspond to documents 304, and the control objectives library may correspond to control objectives 306.

The dataset may also include risks and controls associated with the electronic documents and the control objectives, according to some embodiments. In some embodiments, the risks may be associated with the electronic documents, and the controls may be associated with the control objectives. The risks may be inferenced from the electronic document based on analyzing the text data in the electronic documents using a neural network model. In addition, the controls may be associated with the control objectives and the controls may be implemented in one or more computing devices in a network and configured to reduce the risks inferenced from the electronic documents. In other embodiments, the risks and controls may be associated with the electronic documents, the control objectives in the control objectives library, or both. In FIG. 3, the controls may correspond to controls 308 and the risks may correspond to risks 310. In some embodiments, the dataset may include citations associated with each of the one or more electronic documents. In FIG. 3, the citations may correspond to citations 312.

At 204, the method 200 includes determining a first set of summaries based on the electronic documents. The summaries of the electronic documents may be generated as output based on the context of the text data therein as determined by the computer-based model, that is, the model applies the one or more techniques and/or algorithms to the text data to determine semantic and syntactical relationships in the text data to enable the model to determine the context of electronic documents and to enable generation of the summaries based on the context. In some embodiments, the model may apply one or more models and/or techniques to the text data to determine the context of the text data and to enable generating the summaries of each electronic document based on the context. In FIG. 3, the first set of summaries may correspond to summaries 314.

In some embodiments, one or more of the electronic documents may include citations, that is, one or more portions of the electronic documents may include therein text that refers to specific standards, guidance, laws, and the like, which organizations are expected to follow. Based on the citation text (e.g., key terms and phrases, and its area of law and/or regulation, the models may identify the control objectives. In some embodiments, the citations may provide additional context to the models for determining the first set of summaries from the electronic documents.

At 206, the method 200 includes extracting a set of embeddings from one or more control objectives in the control objectives library. In some embodiments, the model may be applied to all the control objectives in the control objectives library to extract the embeddings therefrom. In other embodiments, the neural network model may identify one or more control objectives from the control objectives library that may be mapped to the electronic documents and extract the embeddings from these mapped control objectives.

The method 200 may further include determining a second set of summaries based on the control objectives library. In some embodiments, the computing device may apply the model to the control objectives in the control objectives library (e.g., text data of the control objectives) to generate summaries of the control objectives. In this regard, in some embodiments, the embeddings may be extracted from the summaries of the control objectives. In FIG. 3, the second set of summaries may also correspond to summaries 314, that is, the summaries of the electronic documents and the summaries of the control objectives may be embodied in summaries 314.

The summaries and embeddings may also be determined based on risks and controls associated with the electronic documents and control objectives library. In some embodiments, the dataset including the electronic documents obtained by the computing device may also include the risks and controls. As such, the summaries of the electronic documents may also be based on the risks associated with the electronic document. In addition, the embeddings extracted from the control objectives in the control objectives library may include embeddings extracted from the controls associated with the control objectives library. In FIG. 3, the embeddings may correspond to embeddings 316.

The control objectives library includes a plurality of control objectives. In some embodiments, the control objectives library may include control objectives mapped to electronic documents. For example, the control objectives in the control objectives library may be mapped to electronic documents in a baseline dataset used to initially train the models or in a reference dataset used to iteratively train the models with new data based on the operations of the model. The electronic documents may include, for example, historical electronic documents, including historical versions of electronic documents, that the entity associated with the network such as, for example, network 106 in FIG. 1 utilizes as guidelines in controlling operations in the one or more computing devices in the network. In some embodiments, the computing device may store the electronic documents in the memory, including the electronic documents associated with the alerts and/or the electronic documents in the reference or baseline datasets. In other embodiments, the computing device may store the electronic documents in the reference or baseline datasets in the memory of another computing device. In addition, in some embodiments, one or more of the electronic documents may include citations (e.g., portion(s) of the electronic document) that includes text referring to standards/guidance. The control objectives library may also include unmapped control objectives, that is, control objectives that are not mapped to the electronic documents obtained as input (e.g., in the alert).

In some embodiments, the method 200 may further include determining a second set of summaries based on the first set of control objectives by the neural network model. In this regard, the set of embeddings may be determined based on the second set of summaries, that is, the neural network model may apply the one or more models and/or techniques to the text data of the second set of summaries of the control objectives in the control objectives library and may extract the embeddings therefrom. In FIG. 3, the second set of summaries may also be embodied in summaries 314.

At 208, the method 200 includes determining, based on a prompt, a first set of control objectives based on the first set of summaries and the set of embeddings. In some embodiments, the first set of control objectives may be further based on citations in one or more of the electronic documents. In addition, in some embodiments, the neural network model may identify the control objectives based on the first set of summaries and the set of embeddings and based on a prompt provided as input to the neural network model. The prompt may be engineered by a user using prompt engineering, the prompt may be configured to provide the neural network model with additional text data to enable the model to determine control objectives to associate with the electronic documents from the first set of summaries and the set of embeddings and based on the context of the prompt, according to some embodiments. In FIG. 3, the prompt may correspond to prompt 318, and the second set of control objectives may correspond to control objectives candidates 320. As used herein, “prompt engineering” refers to the process of formatting input (e.g., text data) in such a way that the input prompt describes the task(s) a neural network model is to perform as a command. Prompt engineering may include phrasing a query, providing relevant context, and may serve as in-context learning that enables the model to learn from the prompt to perform the processing tasks.

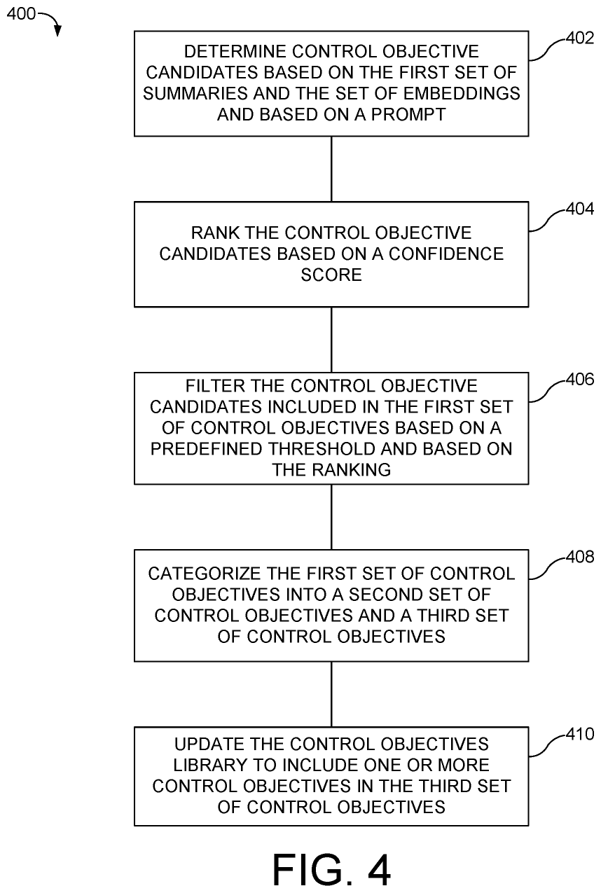

FIG. 4 illustrates a flow diagram of a method 400, according to some embodiments. The method 400, or one or more portions thereof, may be performed by the computing device 102 of FIG. 1.

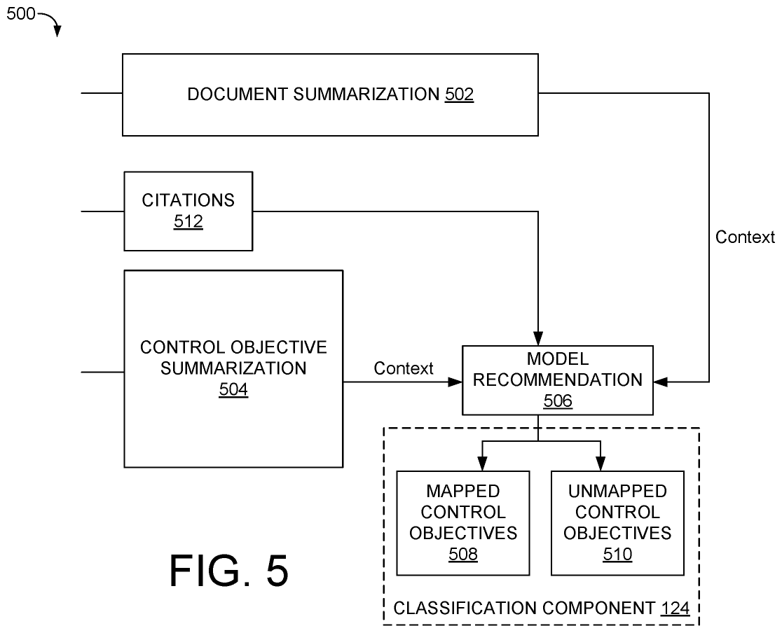

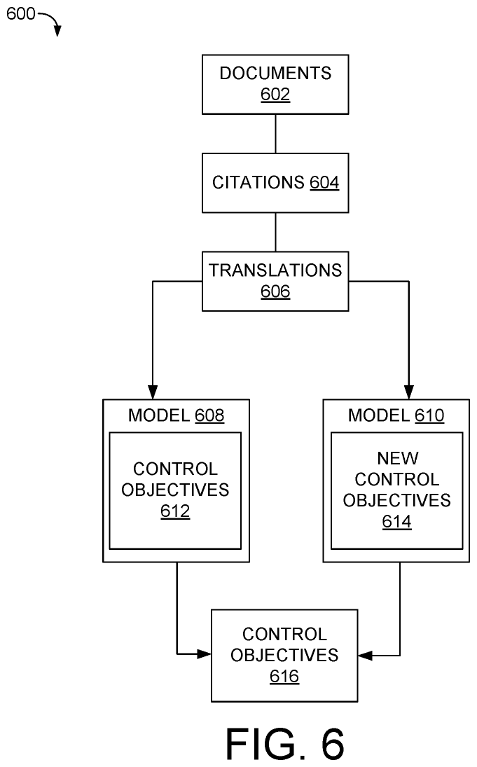

FIG. 5 illustrates a diagrammatic view of a system 500 performing the method 400, according to some embodiments. FIG. 6 illustrates a diagrammatic view of a system 600 performing the method 400, according to some embodiments. The method 400 may be described in conjunction with the system 300, system 500, and system 600.

At 402, the method 400 includes determining control objective candidates based on the first set of summaries and the set of embeddings and based on a prompt. The control objective candidates may be a plurality of control objective candidates that includes therein the first set of control objectives, that is, the first set of control objectives may be selected from the control objective candidates determined by the model. In FIG. 3, the control objective candidates may correspond to control objective candidates 320.

The control objective candidates may also be determined based on summarization of the control objectives, according to some embodiments. In this regard, the model may apply one or more techniques and/or algorithms (e.g., NLP models) to the text data of the control objectives in the control objectives library and generate summarizations of the control objectives based on the context of the text data therein. From the summarizations, the model may then extract the embeddings. In FIG. 5, the document summarization may correspond to document summarization 502 and the control objective summarization may correspond to control objective summarization 504.

In FIG. 6, the electronic documents obtained in the data processing pipeline corresponds to electronic documents 602. In addition, the citations of the electronic documents corresponds to citations 604. In some embodiments, the citations 604 may also correspond to citations 512 in FIG. 5, and citations 322 in FIG. 3. The computing device may also utilize one or more models to translate the text in the electronic document. For example, the text in the electronic document may be in a language other than English, and the text may be translated into English to enable processing and to provide a standard format by which users may read and understand the electronic documents, summarizations, embeddings, and other like data. In FIG. 6, the translations corresponds to translations 606.

The computing device may utilize a first model to generate one or more recommendations of control objective candidates based on the control objectives in the control objectives library, that is, the model may identify and determine that one or more of the control objectives in the control objectives library (e.g., second set of control objectives) that may apply and may be associated to other electronic documents may also be associated with the electronic documents in the processing pipeline. Therefore, the model may generate the second set of control objectives based on the determination. In FIG. 6, the control objectives may correspond to control objectives 612.

The computing device may utilize a second model to generate one or more new control objective candidates as recommendation, the new control objectives corresponding to control objectives not included in the control objectives library. In this regard, the model may predict the new control objectives based on data including the control objectives in the control objectives library, the summaries and embeddings of the electronic documents and control objectives in the control objectives library, the risks and controls associated therewith, or any combinations thereof. In some embodiments, the model may predict the new control objectives based on selections by one or more users of control objectives for implementation into the network. In FIG. 6, the second model corresponds to model 610 and the new control objectives corresponds to new control objectives 614.

The recommendations of control objectives from the control objectives library and the predicted new control objectives may be provided as output (e.g., first set of control objectives) in an output dataset. The dataset may be output to one or more computing devices such as, for example, computing device 108 in FIG. 1. In FIG. 6, the control objectives output by the first and second models corresponds to control objectives 616.

At 404, the method 400 includes ranking the control objective candidates based on a confidence score. The model, based on the summaries, embeddings, and the prompt, may determine a number of control objective candidates that can be associated with the electronic documents in the data processing pipeline. In some embodiments, the model may determine a large number of control objective candidates that can be associated with the electronic documents. The number of candidates may be reduced by the model by ranking the control objective candidates based on the confidence score associated with each candidate.

The confidence score of each control objective candidate may be determined based on the relationship between the summaries and the embeddings. In some embodiments, the relationship may be based on a semantic relationship between the summaries and embeddings. In other embodiments, the relationship may be based on a syntactic relationship between the summaries and embeddings. In some embodiments, the relationship may be based on the semantic and syntactic relationships between the summaries and embeddings.

The confidence score of each control objective may also be determined based on the context of the prompt. In this regard, the model may analyze the text data in the prompt, and based on the context of the prompt, the model may further determine the semantic relationship, the syntactic relationship, or both, between the summaries and embeddings and determine the confidence score based on the relationships. In FIG. 3, the ranking of the control objective candidates may also be embodied in control objectives candidates 320.

At 406, the method 400 includes filtering the control objective candidates included in the first set of control objectives based on a predefined threshold and based on the ranking. The model may determine a number of control objective candidates that may be associated with the electronic documents in the processing pipeline. In some embodiments, the model may determine a large number of control objective candidates for association with the electronic documents, and the model may reduce the number of candidates by filtering the n number of candidates for further processing based on the rankings of the control objective candidates, that is, the top n ranked control objective candidates may be selected for further processing and the other control objective candidates may not be further processed. In FIG. 3, the filtering may be embodied in control objectives candidates 320.

At 408, the method 400 includes categorizing, by the computing device, the first set of control objectives into a second set of control objectives and a third set of control objectives. The second set of control objectives may correspond to mapped control objectives in the control objectives library. That is, the second set of control objectives may be mapped to electronic documents implemented as guidelines in the network of the computing device such as, for example, network 106 of computing device 102 in FIG. 1.

The third set of control objectives may correspond to unmapped control objectives. That is, the third set of control objectives may correspond to control objectives not in the control objectives library. The model may generate the control objective candidates in the third set of control objectives based on the summaries, embeddings, and based on the prompt. In some embodiments, the prompt may include data corresponding to in-context learning prompts that may be used to train the model to generate the new control objective candidates based on the summaries and embeddings. For example, the prompt may include one or more previous control objective candidates that were generated by the models and selected by a user for implementation into the network 106 of FIG. 1. In FIG. 3, the categorization may correspond to categorize control objectives 326, the mapped control objectives correspond to mapped control objectives 326, and the unmapped control objectives correspond to unmapped control objectives 328. In FIG. 5, the model for recommendation of control objective candidates corresponds to model recommendation 506, the mapped control objectives corresponds to mapped control objectives 508, and the unmapped control objectives corresponds to unmapped control objectives 510. In addition, in FIG. 5, the citations for associating the mapped control objectives 508 and the unmapped control objectives 510 to the electronic documents obtained in the data processing pipelines may be obtained from citations 512. The model recommendation 506 may obtain the citations for the electronic documents from citations 512 and may associate the corresponding citations with the control objective candidates, e.g., mapped control objectives 508 and unmapped control objectives 510.

At 410, the method 400 includes updating the control objectives library to include one or more control objectives in the third set of control objectives. The mapped and unmapped control objective candidates may be included in an output dataset. One or more of the unmapped control objectives candidates may then be obtained by the computing device as input based on a selection of the unmapped control objective candidate for implementation into the network such as, for example, network 106 in FIG. 1.

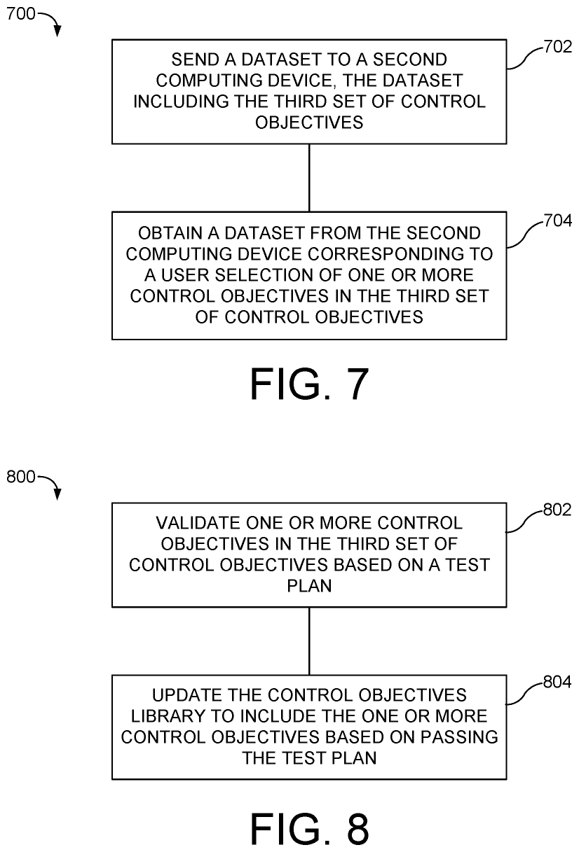

FIG. 7 illustrates a flow diagram of a method 700, according to some embodiments. The method 700, or one or more portions thereof, may be performed by the computing device 102 of FIG. 1. The method 700 may be an embodiment of operation 410 in method 400 of FIG. 4. In addition, the method 700 may be described in conjunction with the system 300 of FIG. 3.

At 702, the method 700 includes sending a dataset to a second computing device, the dataset comprising the third set of control objectives. In some embodiments, the dataset output to the computing device may include the second set of control objectives and the third set of control objectives, that is, the categorized control objective candidates of the first set of control objectives may be included in the output dataset sent to the second computing device.

The computing device may send the dataset as output to the second computing device, to enable the second computing device to select one or more control objectives for implementation into the network of the computing device based on the one or more electronic documents in the data processing pipeline. The second computing device may include instructions stored in the memory and executable by the processor of the second computing device, the instructions including a user interface or graphical user interface that may be displayed on a display device associated with the second computing device to display the control objectives included in the output dataset obtained from the computing device. The user of the second computing device may then provide one or more inputs to the interface corresponding to a user selection of one or more control objectives to be implemented into the network of the computing device. In some embodiments, the dataset output by the computing device may also include, but is not limited to, the summaries of the electronic documents, summaries of the control objectives, risks, controls, citations, other data, or any combinations thereof. In FIG. 3, the second computing device corresponds to computing device 108, the display device corresponds to display device 330, and the user interface or graphical user interface corresponds to interface 332.

At 704, the method 700 includes obtaining a second dataset from the second computing device corresponding to a user selection of the one or more control objectives in the third set of control objectives. The second computing device may then send the second dataset including the inputs obtained from the user to the computing device, the inputs indicative of the user's selection of control objectives for implementation. The second dataset output by the second computing device may include one control objective. In some embodiments, the second dataset may include one or more control objectives for implementation. In addition, in some embodiments, the second dataset may also include, but is not limited to, the summaries of the electronic documents, summaries of the control objectives, risks, controls, citations, other data, or any combinations thereof. For example, the user may confirm/modify/edit one or more of the summaries, risks, controls, citations, other data, or any combinations thereof and send the data back to the computing device for implementation.

FIG. 8 illustrates a flow diagram of a method 800, according to some embodiments. The method 800, or one or more portions thereof, may be performed by the computing device 102 of FIG. 1. The method 800 may be an embodiment of operation 410 in method 400 of FIG. 4.

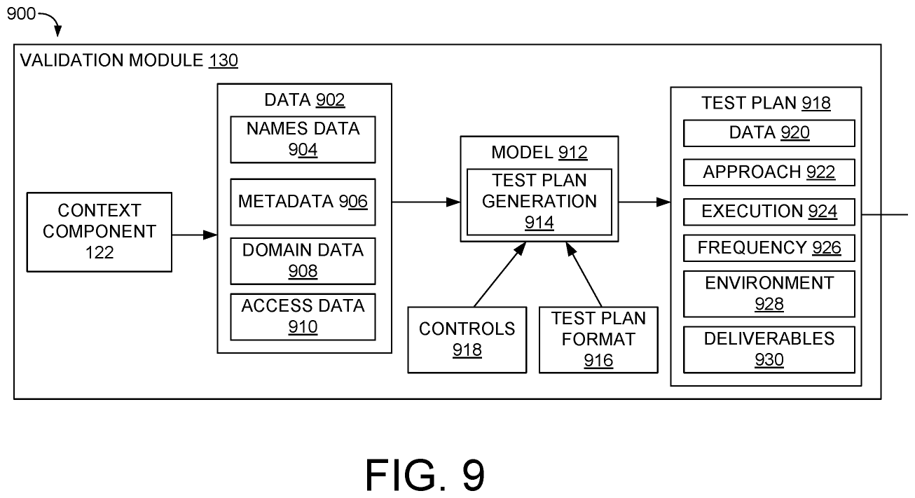

FIG. 9 is a diagrammatic view of a system 900 performing the method 800, according to some embodiments. The method 800 will be described in conjunction with the system 900.

At 802, the method 800 includes validating one or more control objectives in the third set of control objectives based on a test plan. In FIG. 9, the validation of the control objectives may be performed by validation component 130. In some embodiments, the computing device 102 of FIG. 1 may include the validation component 130 therein.

In some embodiments, the method 800 may include generating a test plan for validating the control objective. The model may generate the test plan to validate each control objectives based on a test plan format and based on one or more controls obtained as input. That is, in some embodiments, the control objectives selected by the user of the second computing device may need validation prior to implementation into the system. The dataset obtained from the second computing device including the user selected control objectives from the third set of control objectives may include one or more controls engineered by the user for implementation to accomplish the control objective. In some embodiments, the model may determine controls for implementation based on the control objective and the dataset output by the computing device and sent to the second computing device may include these controls, and the one or more inputs from the user of the second computing device may include the user's selection of one or more of the controls. The computing device may obtain the controls as input and apply the controls into a test plan for validating the control objective prior to implementation.

The method 800 may include obtaining one or more datasets corresponding to data associated with the network in which the control objectives will be implemented. The datasets may include name data, metadata, domain data, data access data, other data, or any combinations thereof. The name data may include names of data sources that may be accessed for validation purposes. The metadata may include metadata of transactions and other operations performed on the network. The domain data may include domain data of the computing devices performing the transactions or other operations on the network. The access data may include the data being accessed in the network during the transactions and other operations.

The data may be obtained by the computing device and utilized by the model to enable the model to generate the test plan and validate the control objective based on the datasets and based on the controls. In FIG. 9, the names data corresponds to names data 904, the metadata corresponds to metadata 906, the domain data corresponds to domain data 908, the access data corresponds to access data 910. In addition, these datasets may correspond to data 902, and may be obtained from a datastore such as, for example, context component 122 in FIG. 1. In other embodiments, although not shown in FIG. 9, the data may be obtained from another computing device such as, for example, computing device 104 in FIG. 1.

The method 800 may further include obtaining a test plan format. The text plan format may provide the base format for test plans, that is, the model may generate test plans based on this base test plan format using the datasets obtained by the computing device, and the model may then apply the controls as input to the datasets to generate the test plan. In FIG. 9, the model corresponds to model 912, the test plan generation corresponds to test plan generation 914, the test plan format corresponds to test plan 916, and the controls corresponds to controls 918.

At 804, the method 800 includes updating the control objectives library to include the one or more control objectives based on passing the test plan. The test plan may be configured by the model to obtain the data from the network, e.g., from a datastore of a computing device in the network, and based on the controls and test plan format, perform operations in accordance with the test plan using the obtained data to determine whether the control objective may be implemented into the computing devices in the network.

The test plan may therefore be performed using the data of the network including, but not limited to, the names data, metadata, domain data, access data, other data, or any combinations thereof. The model may also determine the approach for fulfilling the test plan. In this regard, the model may, based on the test plan format, determine how to apply the controls to the data and to thereby generate a result that may be indicative of the performance of the control objective and the controls. The computing device and/or the model may then execute the test plan according to the designed approach. In some embodiments, the test plan for the control objective may be executed on the network of the computing device. In other embodiments, the test plan for the control objective may be executed in a test environment that simulates the environment of the network and the computing devices therein. The model may also determine a frequency that the test plan may need to be executed. That is, the test plan may need to be executed more than once in order to properly validate the test plan. As such, the model may determine a frequency for executing the test plan. In some embodiments, the frequency may include one cycle of execution. In other embodiments, the frequency may include a plurality of cycles of execution performed over a period of time. For example, the test plan may be executed once a day for a week. In addition, the model may define deliverables that may be expected to determine whether the control objectives passes validation. For example, the test plan may validate controls based on a control objective for preventing contingent users (e.g., contractors) from using computing devices in the network until a point in time when the contingent user has passed the security authentication procedures, that is, if the network data includes metadata and/or access data having timestamps indicating the contingent user was able to access the network through computing devices of the network before their security authentication was completed, the control objective and corresponding controls fails the validation. The test plan may thereby have one or more deliverables that may be defined in the test plan to enable the model or the users responsible for implementing controls based on the control objectives to determine whether the controls implemented based on the control objective has successfully passed validation. In FIG. 9, the test plan corresponds to test plan 916, the data corresponds to data 920, the approach corresponds to approach module 922, the execution corresponds to execution module 924, the frequency corresponds to frequency module 926, the environment corresponds to environment module 928, and the deliverables corresponds to deliverables module 930.

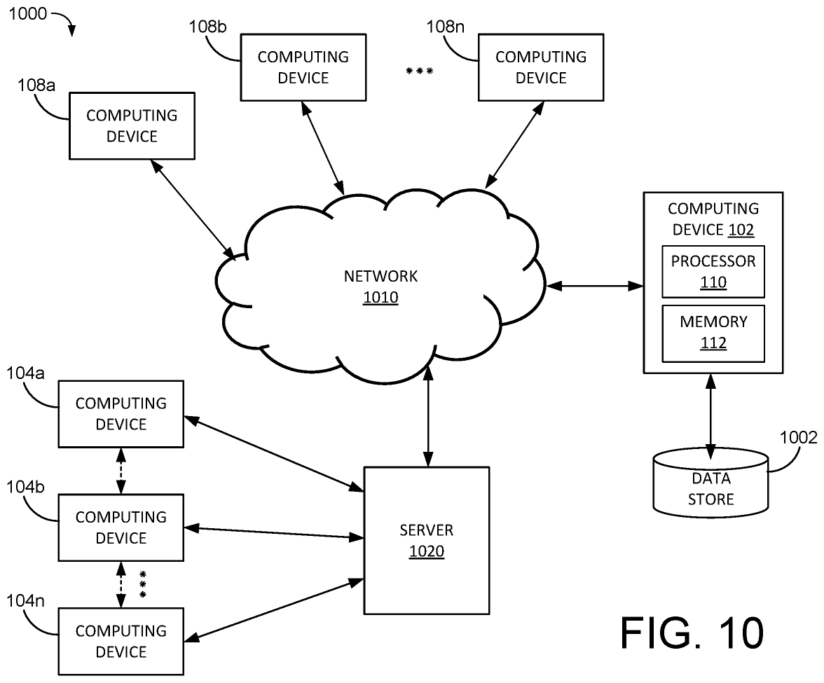

FIG. 10 is a block diagram illustrating a network-based system 1000, according to some embodiments.

Not all of these components may be required to practice one or more embodiments, and variations in the arrangement and type of the components may be made without departing from the spirit or scope of various embodiments of the present disclosure. In various embodiments, the network-based system 1000 may include the computing device 102 of FIG. 1. The computing device 102 may be in communicable connection with a network 1010 to send and receive information corresponding to one or more datasets with one or more other computing devices including computing device 104a, computing device 104b, and through computing device 104n (hereinafter referred to as computing device 104) and computing device 108a, computing device 108b, and through computing device 108n (hereinafter referred to as computing device 108). In network-based system 1000, the computing device 104 may be associated with computing devices for performing one or more processing operations to fulfill the processing tasks, and the computing device 108 may be associated with computing devices of users sending pipeline jobs to computing device 102 and/or to system 100 as shown in FIG. 1.

The computing devices 104 and computing devices 108 may be in communicable connection with the computing device 102. In some embodiments, the computing devices 104 and computing devices 108 may be in communicable connection with one or more computing devices through network 1010 and/or through server 1020. In some embodiments, the one or more other computing devices 104 and the one or more other computing devices 108 may be computerized tools (e.g., any suitable combination of computer-executable hardware and/or computer-executable software) which can be configured to perform the one or more processing tasks in accordance with the present disclosure. For example, in some embodiments, the computing device 104 in FIG. 1 may include one or more of the components of computing device 102 therein to perform the pipeline processing tasks orchestrated by computing device 102. In some embodiments, each of the computing devices 104 may be a node or may include a cluster of nodes for performing different types of tasks for determining control objective candidates for recommendation in accordance with the present disclosure.

In some embodiments, computing device 102 and computing devices 104 may be any type of processor-based platforms that are connected to network 1010 such as, without limitation, servers, nodes, cluster of nodes, personal computers, digital assistants, personal digital assistants, smart phones, pagers, digital tablets, laptop computers, Internet appliances, cloud-based processing platforms, and other processor-based devices either physical or virtual, including processing and memory resources to enable the computing devices to fulfill the processing tasks. In some embodiments, the computing device 102 and computing devices 104 may be specifically programmed with one or more application programs in accordance with one or more principles/methodologies detailed herein. In some embodiments, the computing device 102 and/or the computing devices 104 may be specifically programmed with the context component 122, summary component 124, identification component 126, classification component 128, validation component 130, model component 132, or any combinations thereof, to leverage one or more machine learning models or neural network models in accordance with one or more principles/methodologies detailed herein. The computing device 108 may also include therein one or more application programs in accordance with one or more principles/methodologies detailed herein to enable the computing device 108 to be in electronic communication with the computing device 102, the computing devices 104, or both, to send and receive data between the computing devices, and to enable the computing device 108 to display the information in the data obtained from the other computing devices, and to enable the user of the computing device 108 to provide one or more inputs that may be obtained by the other computing devices to indicate the user's selection of control objectives for implementation. In some embodiments, the computing device 102, computing devices 104, and computing devices 108 may operate on any of a plurality of operating systems capable of supporting a browser or browser-enabled application, such as Microsoft™, Windows™, and/or Linux. In some embodiments, the computing device 102, computing devices 104, and computing devices 108 each may include at least include a computer-readable medium, such as a random-access memory (RAM) or FLASH memory, coupled to a processor.

In some embodiments, the computing device 102 and/or the computing devices 104 shown may be accessed by, for example, the computing devices 108 by executing a browser application program such as Microsoft Corporation's Internet Explorer™, Apple Computer, Inc.'s Safari™, Mozilla Firefox, and/or Opera to obtain data from the network 1010. In some embodiments, the computing devices 104 may communicate over the exemplary network 1010 with the computing device 102 to obtain predictions for the control objectives, and which may be provided to computing devices 104 based on computing resource availability at computing devices 104.

In some embodiments, the network-based system 1000 may include at least one data store 1002. The data store 1002 may have stored therein one or more datasets corresponding to historical electronic documents, citations, controls, risks, and corresponding control objectives. The data store 1002 may have stored therein one or more baseline datasets or reference datasets for training the models of the computing device 102 and computing devices 104. The data store 1002 may also have stored therein one or more datasets for operations performed in the network 1010 using the computing device 102, the computing devices 104, the computing devices 108, and other computing devices such as, for example, computing devices of users performing online transactions on the network 1010. For example, the data store 1002 may have stored therein data 902. The data store 1002 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the network-based system 1000 may also include and/or involve one or more cloud components. Cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some embodiments, the computer-based systems/platforms, computer-based devices, components, media, and/or the computer-implemented methods of the present disclosure may be specifically configured to operate in or with cloud computing/architecture such as, but not limiting to infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing device (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-200, RTR0, SHA-1, SHA-2, Tiger (TTH), WHIRLPOOL, RNGs).

The machine learning models and/or neural network models as described in the various embodiments herein can be any suitable computer-implemented artificial intelligence algorithm that can be trained (e.g., via supervised learning, unsupervised learning, reinforcement learning, generative learning) to receive input data and to generate output data based on the received input data (e.g., neural network, linear regression, logistic regression, decision tree, support vector machine, naive Bayes, and/or so on). In various aspects, the input data can have any suitable format and/or dimensionality (e.g., character strings, scalars, vectors, matrices, tensors, images, and/or so on). Likewise, the output data can have any suitable format and/or dimensionality (e.g., character strings, scalars, vectors, matrices, tensors, images, and/or so on). In various embodiments, the model(s) can be implemented to generate any suitable determinations and/or predictions in any suitable operational environment (e.g., can be implemented in a payment processing context, where the model receives payment data, transaction data, and/or customer data and determines/predicts whether given transactions are fraudulent, whether given customers are likely to default, and/or any other suitable financial determinations/predictions, and/or so on).

In some embodiments, a system includes a processor, a non-transitory computer readable media, a context component, the context component being configured to obtain a first dataset corresponding to electronic documents and a control objectives library, a summary component, the summary component being configured to, by applying a neural network model to the electronic documents, produce a first set of summaries, the summary component also being configured to, by applying the neural network model to control objectives in the control objectives library, produce a set of embeddings, and an identification component, the identification component being configured to, based on inputting a prompt to the neural network model, determine a first set of control objectives based on the first set of summaries and the set of embeddings.

In some embodiments, the system further includes a classification component, the classification component being configured to categorize the first set of control objectives into a second set of control objectives and a third set of control objectives.

In some embodiments, the second set of control objectives correspond to mapped control objectives in the control objectives library associated with the electronic documents.

In some embodiments, the third set of control objectives correspond to unmapped control objectives associated with the electronic documents.

In some embodiments, the third set of control objectives includes one or more control objectives not in the control objectives library.

In some embodiments, a portion of one or more of the electronic documents further includes citations.

In some embodiments, the summary component is further configured to, by applying the neural network model to the citations, produce the first set of summaries, the first set of summaries further includes key terms and phrases extracted from text data of the citations.

In some embodiments, the summary component is further configured to apply the neural network model to determine the first set of summaries and the set of embeddings based on risks and controls associated with the electronic documents, citations, control objectives in the control objectives library, or any combinations thereof.

In some embodiments, the neural network model includes a first neural network model, the summary component applies the first neural network model to determine the first set of summaries and the set of embeddings, and a second neural network model, the identification component applies the second neural network model to the first set of summaries and the set of embeddings to determine the first set of control objectives based on the prompt.

In some embodiments, a computer-implemented method for determining control objectives for documents includes obtaining, by a computing device, electronic documents and a control objectives library, determining, by a first model, a first set of summaries based on the electronic documents. In some embodiments, a portion of one or more of the electronic documents further includes citations, the first set of summaries being determined based on the citations. The method further includes extracting, by the first model, a set of embeddings from one or more control objectives in the control objectives library, and determining, by a second model and based on a prompt, a first set of control objectives based on the first set of summaries and the set of embeddings.

In some embodiments, the method further includes determining, by the second model, control objective candidates based on the first set of summaries and the set of embeddings and based on the prompt, ranking, by the computing device, the control objective candidates based on a confidence score, filtering, by the computing device, the control objective candidates included in the first set of control objectives based on a predefined threshold and based on the ranking, categorizing, by the computing device, the first set of control objectives into a second set of control objectives and a third set of control objectives, and updating, by the computing device, the control objectives library to include one or more control objectives in the third set of control objectives. In some embodiments, the second set of control objectives corresponds to mapped control objectives in the control objectives library.

In some embodiments, the third set of control objectives correspond to unmapped control objectives.

In some embodiments, the third set of control objectives includes one or more control objectives not in the control objectives library, the second model determining the one or more control objectives in the third set of control objectives based on a prompt defining parameters for determining the one or more control objectives.

In some embodiments, the method further includes validating, by the computing device, the third set of control objectives based on a test plan. In some embodiments, the control objectives library is updated with the one or more control objective in the third set of control objectives based on passing the test plan.

In some embodiments, the method further includes determining, by the first model, a second set of summaries based on the control objectives library. In some embodiments, the set of embeddings includes embeddings extracted from the second set of summaries.

In some embodiments, the first set of summaries and the set of embeddings are determined by the first model based on risks and controls associated with the electronic documents, the control objectives library, or both.

In some embodiments, a computer-implemented method for generating control objective recommendations based on documents includes determining, by a first model, a first set of summaries based on electronic documents, determining, by the first model, a second set of summaries based on a control objectives library, extracting, by the first model, a set of embeddings from the second set of summaries, determining, by a second model and based on a prompt, a first set of control objectives based on the first set of summaries and the set of embeddings, categorizing the first set of control objectives into a second set of control objectives and a third set of control objectives, validating one or more control objectives in the third set of control objectives based on a test plan, and updating the control objectives library to include the one or more control objectives based on passing the test plan. In some embodiments, the second set of control objectives corresponds to mapped control objectives in the control objectives library.

In some embodiments, the first set of summaries and the second set of summaries are determined by the first model based on risks and controls associated with the electronic documents, citations, control objectives in the control objectives library, or any combinations thereof.

In some embodiments, the method further includes determining, by the second model, control objective candidates based on the first set of summaries and the set of embeddings and based on the prompt, ranking the control objective candidates based on a confidence score, filtering the control objective candidates included in the first set of control objectives based on a predefined threshold and based on the ranking, sending a dataset to a second computing device, the dataset including the third set of control objectives, and obtaining a second dataset from the second computing device corresponding to a user selection of the one or more control objectives in the third set of control objectives. In some embodiments, the third set of control objectives correspond to unmapped control objectives.

In some embodiments, one or more of the electronic documents includes citations, the first set of summaries determined by the first model is further based on the citations.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A system comprising:
a processor;
a non-transitory computer readable media;
a context component,
wherein the context component is configured to obtain a first dataset corresponding to electronic documents and a control objectives library;
a summary component,
wherein the summary component is configured to, by applying a neural network model to the electronic documents, produce a first set of summaries,
wherein the summary component is configured to, by applying the neural network model to control objectives in the control objectives library, produce a set of embeddings; and
an identification component,
wherein the identification component is configured to, based on inputting a prompt to the neural network model, determine a first set of control objectives based on the first set of summaries and the set of embeddings.

2. The system of claim 1, further comprising:
a classification component,
wherein the classification component is configured to categorize the first set of control objectives into a second set of control objectives and a third set of control objectives.

3. The system of claim 2, wherein the second set of control objectives correspond to mapped control objectives in the control objectives library associated with the electronic documents.

4. The system of claim 2, wherein the third set of control objectives correspond to unmapped control objectives associated with the electronic documents.

5. The system of claim 4, wherein the third set of control objectives includes one or more control objectives not in the control objectives library.

6. The system of claim 1, wherein a portion of one or more of the electronic documents further comprises citations.

7. The system of claim 6, wherein the summary component is further configured to, by applying the neural network model to the citations, produce the first set of summaries, wherein the first set of summaries further comprises key terms and phrases extracted from text data of the citations.

8. The system of claim 1, wherein the summary component is further configured to apply the neural network model to determine the first set of summaries and the set of embeddings based on risks and controls associated with the electronic documents, citations, control objectives in the control objectives library, or any combinations thereof.

9. The system of claim 1, wherein the neural network model comprises:
a first neural network model,
wherein the summary component applies the first neural network model to determine the first set of summaries and the set of embeddings, and
a second neural network model,
wherein the identification component applies the second neural network model to the first set of summaries and the set of embeddings to determine the first set of control objectives based on the prompt.

10. A computer-implemented method for determining control objectives for documents comprising:
obtaining, by a computing device, electronic documents and a control objectives library;
determining, by a first model, a first set of summaries based on the electronic documents, wherein a portion of one or more of the electronic documents further comprises citations, the first set of summaries being determined based on the citations;
extracting, by the first model, a set of embeddings from one or more control objectives in the control objectives library; and
determining, by a second model and based on a prompt, a first set of control objectives based on the first set of summaries and the set of embeddings.

11. The method of claim 10, the method further comprises:
determining, by the second model, control objective candidates based on the first set of summaries and the set of embeddings and based on the prompt;
ranking, by the computing device, the control objective candidates based on a confidence score;
filtering, by the computing device, the control objective candidates included in the first set of control objectives based on a predefined threshold and based on the ranking;
categorizing, by the computing device, the first set of control objectives into a second set of control objectives and a third set of control objectives; and
updating, by the computing device, the control objectives library to include one or more control objectives in the third set of control objectives;
wherein the second set of control objectives corresponds to mapped control objectives in the control objectives library.

12. The method of claim 11, wherein the third set of control objectives correspond to unmapped control objectives.

13. The method of claim 11, wherein the third set of control objectives includes one or more control objectives not in the control objectives library, the second model determining the one or more control objectives in the third set of control objectives based on a prompt defining parameters for determining the one or more control objectives.

14. The method of claim 11, the method further comprises:
validating, by the computing device, the third set of control objectives based on a test plan,
wherein the control objectives library is updated with the one or more control objective in the third set of control objectives based on passing the test plan.

15. The method of claim 10, the method further comprises:
determining, by the first model, a second set of summaries based on the control objectives library,
wherein the set of embeddings comprises embeddings extracted from the second set of summaries.

16. The method of claim 15, wherein the first set of summaries and the set of embeddings are determined by the first model based on risks and controls associated with the electronic documents, the control objectives library, or both.

17. A computer-implemented method for generating control objective recommendations based on documents comprising:
determining, by a first model, a first set of summaries based on electronic documents;
determining, by the first model, a second set of summaries based on a control objectives library,
extracting, by the first model, a set of embeddings from the second set of summaries;
determining, by a second model and based on a prompt, a first set of control objectives based on the first set of summaries and the set of embeddings;
categorizing the first set of control objectives into a second set of control objectives and a third set of control objectives;
validating one or more control objectives in the third set of control objectives based on a test plan; and
updating the control objectives library to include the one or more control objectives based on passing the test plan;
wherein the second set of control objectives corresponds to mapped control objectives in the control objectives library.

18. The method of claim 17, wherein the first set of summaries and the second set of summaries are determined by the first model based on risks and controls associated with the electronic documents, citations, control objectives in the control objectives library, or any combinations thereof.

19. The method of claim 17, the method further comprises:
determining, by the second model, control objective candidates based on the first set of summaries and the set of embeddings and based on the prompt;
ranking the control objective candidates based on a confidence score;
filtering the control objective candidates included in the first set of control objectives based on a predefined threshold and based on the ranking;
sending a dataset to a second computing device, the dataset comprising the third set of control objectives; and
obtaining a second dataset from the second computing device corresponding to a user selection of the one or more control objectives in the third set of control objectives;
wherein the third set of control objectives correspond to unmapped control objectives.

20. The method of claim 19, wherein one or more of the electronic documents comprises citations, wherein the first set of summaries determined by the first model is further based on the citations.
